(19) United States
(12) Patent Application Publication
(10) Pub. No.: US 2008/0106121 A1
(43) Pub. Date: May 8, 2008

(54) WIND SHIELD WITH METALLIC MESH

(76) Inventor: Douglas Ryan Lissner, Tustin, CA (US)

Correspondence Address: KEVIN J. MACK, 242 CURTNER AVE SUITE N, PALO ALTO, CA, 94306, US

(21) Appl. No.: 11/877,646

(22) Filed: Oct. 23, 2007

Related U.S. Application Data
(60) Provisional application No. 60/857,642, filed on Nov. 6, 2006.

(51) Int. Cl. B60J 1/00

(52) U.S. Cl. 296/190.1

(57) ABSTRACT

A device for shielding wind in a convertible vehicle and a method for manufacturing the same are disclosed. In some embodiments, the device comprises a metallic frame, a metallic mesh; a plurality of slots in the metallic mesh, and a plurality of straps that feed through the plurality of slots to attach the metallic frame and the metallic mesh to a bar in the convertible vehicle. In other embodiments, the method comprises creating a metallic mesh, creating a plurality of openings in the metallic mesh, and creating a metallic frame for the metallic mesh.

### CROSS REFERENCE TO RELATED APPLICATIONS

This application claims priority to U.S. Provisional Application Ser. No. 60/857,642 entitled “Tuff-Break,” filed Nov. 6, 2006, and incorporated herein by reference.

### FIELD OF THE INVENTION

The invention relates generally to automobile accessories, and more particularly, to accessories for convertible automobiles including jeeps.

### BACKGROUND

Jeeps and other types of convertible automobiles are highly valued because of their convenience, durability, and aesthetics. For example, many individuals drive jeeps because of their off-road handling ability. Similarly, many individuals drive convertibles because of their appearance and driving performance. Conventional convertibles may include a folding or retracting roof to protect the driver and passengers from wind, rain, snow, dust, and other weather related conditions. Although the roof is generally made from flexible canvas or vinyl, some convertibles may use rigid plastic, aluminum, or steel.

Conventional convertibles, however, suffer from several shortcomings. First, conventional convertibles do not protect the driver and passengers from air flow over the windshield and around the sides of the vehicle. For example, the driver of a jeep may be exposed to an increasing amount of wind as the jeep accelerates. The wind may not only be a distraction for the driver but also any passengers in the vehicle.

Second, conventional convertibles do not protect the driver and passengers from excessive noise created by the passage of air over the windshield of the convertible. This noise may prevent the driver from hearing other passengers, and may even create a dangerous environment when the driver cannot hear approaching emergency vehicles.

Lastly, items contained within conventional convertibles are prone to theft because of the easy access to the interior of the convertible. For example, a passerby may simply reach into a convertible to gain access. Thus, what is needed is a system and corresponding method that alleviates some or all of the aforementioned shortcomings.

### BRIEF SUMMARY

A device for shielding wind in a convertible vehicle and a method for manufacturing the same are disclosed. In some embodiments, the device comprises a metallic frame, a metallic mesh; a plurality of slots in the metallic mesh, and a plurality of straps that feed through the plurality of slots to attach the metallic frame and the metallic mesh to a bar in the convertible vehicle. In other embodiments, the method comprises creating a metallic mesh, creating a plurality of openings in the metallic mesh, and creating a metallic frame for the metallic mesh.

### BRIEF DESCRIPTION OF THE DRAWINGS

For a detailed description of exemplary embodiments of the invention, reference will now be made to the accompanying drawings in which:

FIG. 1A illustrates a vehicle constructed in accordance with embodiments of the invention, including a shielding and a frame;

FIG. 1B illustrates the vehicle constructed in accordance with embodiments of the invention with a darkened shielding to aid in illustration;

FIG. 2 illustrates the shielding and frame of FIG. 1 in greater detail;

FIG. 3 illustrates the shielding of FIG. 2 in greater detail; and

FIG. 4 illustrates a flow chart of an exemplary process for constructing and using the shielding of FIG. 3.

### NOTATION AND NOMENCLATURE

In the following discussion and in the claims, the terms “including” and “comprising” are used in an open-ended fashion, and thus should be interpreted to mean “including, but not limited to”. Also, the term “couple, “couples,” or “coupled” is intended to mean either an indirect or direct electrical or communicative connection. Thus, if a first device couples to a second device, that connection may be through a direct connection, or through an indirect connection via other devices and connections. In addition, the term “data source” should be interpreted to mean any source of data. For example, a database storing information created by two or more entities represents a plurality of data sources.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

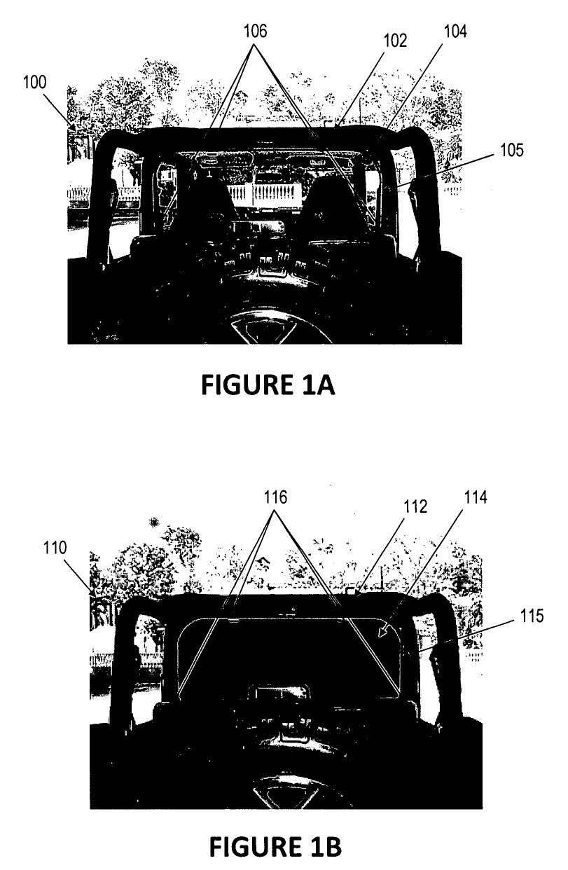

FIG. 1A illustrates a vehicle constructed in accordance with embodiments of the invention. As shown in FIG. 1A the vehicle 100 comprises a roll bar 102, a rear shielding 104 contained within a frame 105, and a plurality of straps 106. The plurality of straps 106 couples the rear shielding 104 to the roll bar 102. The roll bar 102 may represent any length of metal, wood, or other solid material used as a barrier, or as part of the structure of the vehicle 100. The shielding 104 is preferably positioned behind cab of the vehicle 100, as shown in FIG. 1A. The straps 106 may represent any narrow flexible strip of material, such as leather, plastic, and metal, used to bind or secure the shielding 104 to the roll bar 102. The number of placement of the plurality of straps 106 may vary as desired. For example, seven straps may secure the shielding 104 to the roll bar 102—two straps on each side and three straps along the top. The vehicle 100 may represent any type of convertible automobile, such as a Jeep Wrangler, Jeep Scrambler, Jeep Overlander, Suzuki Samurai, Suzuki Sidekick, Geo Tracker, and any other type of automobile capable of being configured with a roll or sport bar. The driver and passengers of the vehicle 100 are capable of seeing through the shielding 104 to ensure driving safety.

FIG. 1B illustrates the vehicle constructed in accordance with embodiments of the invention with a darkened shielding to aid in illustration. As shown in FIG. 1B, the vehicle 110 comprises a roll bar 112, a rear shielding 114 contained within a frame 115, and a plurality of straps 116. The plurality of straps 116 couples the rear shielding 114 to the roll bar 112. The roll bar 112 may represent any length of metal, wood, or other solid material used as a barrier, or as part of the structure of the vehicle 110. The shielding 114 is preferably positioned behind cab of the vehicle 110, as shown in FIG. 1B. The straps 116 may represent any narrow flexible strip of material, such as leather, plastic, and metal, used to bind or secure the shielding 114 to the roll bar 112. The number of placement of the plurality of straps 116 may vary as desired. For example, seven straps may secure the shielding 114 to the roll bar 112—two straps on each side and three straps along the top. The vehicle 110 may represent any type of convertible automobile, such as a Jeep Wrangler, Jeep Scrambler, Jeep Overlander, Suzuki Samurai, Suzuki Sidekick, Geo Tracker, and any other type of automobile capable of being configured with a roll or sport bar. In addition, although the shielding 114 appears solid in FIG. 1B, the shielding is preferably made of mesh so as to make the interior of the cab visible from behind the vehicle, which aids in safe driving.

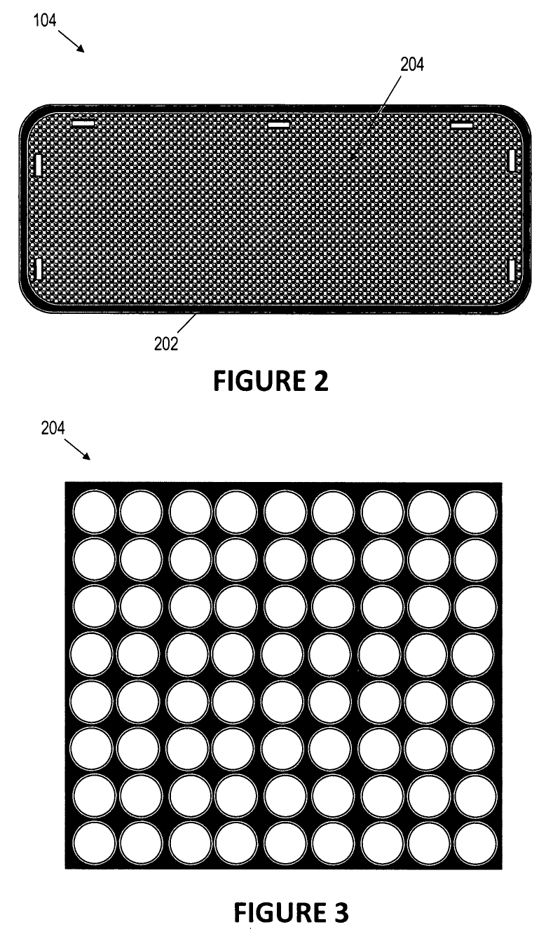

FIG. 2 illustrates the shielding and frame of FIG. 1A in greater detail. As shown, the shielding 104 comprises a frame 202 and an inner mesh 204. Although the frame 202 may represent any type of rigid tubing, in at least some embodiments, the frame 202 represents metal tubing with a circumference of appropriately three inches and an internal diameter of 0.75 of an inch to one inch. The tubing may be powder coated and painted any color as desired. For example, the frame 202 may represent galvanized steel with a blue polyester powder coating. The coating may prevent rust and reinforce the tubing. Although the frame 202 and mesh 204 may come in various shapes and sizes, they are both preferably designed to fit within the roll bar of the vehicle. In addition, the mesh 204 preferably has a plurality of slots. Although not explicitly shown in FIG. 2, the straps 106 may feed through the slots to attach the shielding 104 to the roll bar of the vehicle. The slots are preferably reinforced with plastic inserts to facilitate the insertion of the straps 106 into the slots and around the roll bar. The slots may come in pairs, as shown in FIG. 2, to allow easy feeding of the straps through the slots and around the roll bar. In addition, the dual slot configuration increases the stability of the shielding 204 within the frame 202. Although the straps 106 are preferably made of plastic with Velcro attachment ends any type of thin material may be used as desired. The Velcro attachment generally comprises two strips, one strip with a dense layer of nylon hooks and the other strip with loops that interlock with the nylon hooks.

FIG. 3 illustrates the shielding of FIG. 2 in greater detail. As shown, the shielding 204 comprises a plurality of holes. The shielding 204 is preferably made of metal and the holes in the metal create a mesh like structure. Although the size and position of the holes in the steel may vary in size, in at least some embodiments, the holes are approximately ⅛ of an inch in diameter, and the metal is steel. Thus, the shielding 204 may represent steel mesh. The shielding 204 may be colored and/or patterned as desired. For example, the shielding 204 may have a preformatted design spray painted on the shielding 204. Such deigns increase the aesthetics of the shielding 204. Although the size of the holes may vary as desired, in at least some embodiments the holes are approximately ⅛ of an inch in diameter. Holes of such a diameter may effectively reduce the air flow into the cab of the vehicle and reduce the noise created by the air flow. Thus, the shielding 204 may effectively protect the cabin of the vehicle and provide a secure shielding protecting the interior from potential theft.

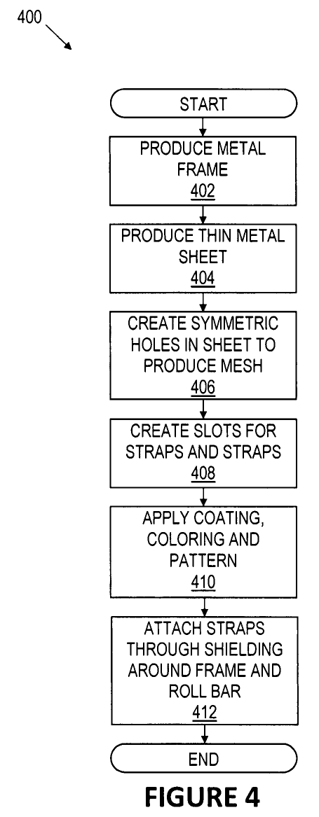

FIG. 4 illustrates a flow chart of an exemplary process for constructing and using the shielding of FIG. 3. The process 400 starts when the metal frame is produced (402). As previously discussed, the frame may represent any type of metal tubing. Then a thin metal sheet is produced for the shielding (404). For example, the metal sheet may represent a sheet of 1/16 of an inch thick powder coated stainless steel. Symmetric holes are then created in the sheet of metal to create a metallic mesh (406). As previous discussed, the holes are preferably approximately ⅛ of an inch in diameter. After the mesh is created, slots are created in the mesh for the straps and the straps themselves are created (408). As previously discussed, the slots are preferably reinforced with plastic to increase durability and come in pairs for easing threading. The straps preferably have Velcro attachments ends for easy fastening. Powder coating, coloring, and a desired design may then be applied to mesh (410). The powder coating may reinforce the mesh to increase its water resistance, rust resistance, and overall durability of the mesh while the coloring and design are primarily designed to increase the aesthetics of the mesh. The process ends when the shielding and frame are installed in a vehicle by attaching the straps through the metal slots in the mesh around the frame and roll bar of the vehicle. Numerous steps may be added, removed, and reordered as desired. For example, powder coating, coloring, and a design may also be applied to the frame to give the mesh and frame combination a consistent look and feel.

The above discussion is meant to be illustrative of the principles and various embodiments of the present invention. Numerous variations and modifications will become apparent to those skilled in the art once the above disclosure is fully appreciated. For example, each of the components of the mobile device may enter into a low power state after a predetermined length of inactivity to conserve power. It is intended that the following claims be interpreted to embrace all such variations and modifications.

What is claimed is:

1. A device for shielding wind in a convertible vehicle, comprising:
a metallic frame;
a metallic mesh;
a plurality of slots in the metallic mesh; and
a plurality of straps that feed through the plurality of slots to attach the metallic frame and the metallic mesh to a bar in the convertible vehicle.

2. The device of claim 1 wherein the metallic frame and the metallic mesh is powder coated to increase rust and water resistance.

3. The device of claim 1 wherein the metallic mesh comprises a plurality of holes configured to reduce the flow of air through the metallic mesh.

4. The device of claim 1 wherein the metallic mesh and metallic frame are designed to be placed behind the cab of the convertible vehicle.

5. The device of claim 1 wherein a plurality of straps comprise a fastener with two strips, one strip with a dense layer of nylon hooks and the other strip with loops that interlock with the nylon hooks.

6. The device of claim 1 wherein the metallic mesh is colored with a preconfigured pattern chosen by a user of the convertible vehicle.

7. The device of claim 1 wherein the metallic mesh is designed to fit within the metallic frame.

8. The device of claim 1 wherein the plurality of slots come in pairs and the plurality of straps are designed to feed through the pairs.

9. The device of claim 1 wherein the convertible vehicle comprises a jeep.

10. The device of claim 1 wherein at least three of the plurality of slots are positioned on the top of the metallic mesh.

11. A method for producing a wind shield for a vehicle, comprising:
creating a metallic mesh;
creating a plurality of openings in the metallic mesh; and
creating a metallic frame for the metallic mesh.

12. The method of claim 11 wherein creating a metallic mesh comprises creating a plurality of holes in a thin metallic sheet.

13. The method of claim 11 wherein creating a plurality of openings comprises creating a first and second slot in the metallic mesh for straps.

14. The method of claim 13 wherein creating a first and second slot comprises reinforcing the first and second slot with plastic.

15. The method of claim 11 further comprising coating the metallic mesh and metallic frame with powder.

16. The method of claim 11 further comprising painting the metallic mesh with a pattern defined by a user of the vehicle.

17. A wind shielding device for a jeep, comprising:
a rigid tubing;
a metallic mesh;
a plurality of openings in the metallic mesh; and
a plurality of bindings that fasten the metallic mesh to the rigid tubing though the plurality of openings.

18. The wind shielding device of claim 17 wherein the plurality of bindings further fasten the rigid tubing to a sports bar on the jeep.

19. The wind shielding device of claim 17 wherein plurality of openings in the metallic mesh are reinforced with rigid inserts.

20. The wind shielding device of claim 17 wherein the plurality of bindings comprise narrow flexible strips of plastic.
